(19) United States
(12) Patent Application Publication
(10) Pub. No.: US 2008/0177668 A1
(43) Pub. Date: Jul. 24, 2008

(54) Computerized person-to-person payment system and method without use of currency

(76) Inventor: Bruno Delean, Andorra La Vella (AD)

Correspondence Address: Soquel Group, LLC, P.O. Box 691, Soquel, CA, 95073, US

(21) Appl. No.: 11/657,237

(22) Filed: Jan. 24, 2007

(51) Int. Cl. G06Q 40/00; H04L 9/32

(52) U.S. Cl. 705/76; 705/64

(57) ABSTRACT

An electronic funds system, including a plurality of payment devices, each payment device including a payment application for (i) transferring funds to another payment device, (ii) receiving funds from another payment device, and (iii) synchronizing transactions with a bank server computer, a queue manager for queuing transactions for synchronization with the bank server computer, an encoder for encrypting transaction information, a proximity communication module for wirelessly communicating with another of the plurality of payment devices over a short range, a wireless communication module for communicating with a client computer and with the bank server computer over a long range, a plurality of client computers, each client computer including a payment device manager for (i) transmitting funds to a payment device, (ii) receiving funds from a payment device, and (iii) setting payment device parameters, and a wireless communication module for communicating with at least one of the plurality of payment devices and with a bank server computer over a long range, and at least one bank server computer, each bank server computer including an account manager for (i) managing at least one bank account associated with at least one of the payment devices, and (ii) processing transactions received from the plurality of payment devices, a decoder for decrypting encrypted transaction information, and a wireless communication module for communicating with the plurality of payment devices and with the plurality of client computers over a long range. A method and a computer-readable storage medium are also described and claimed.

### FIELD OF THE INVENTION

The present invention relates to computerized banking and payment systems.

### BACKGROUND OF THE INVENTION

Conventional methods of making payments include paying with cash, paying by personal check, paying by bank check, paying by bank transfer and paying by credit card. Each of these methods has its drawbacks.

Cash can be lost or stolen. A person may find himself “short” on cash. Cash has to be converted to local currency in foreign countries.

Personal checks can be forged. Many merchants do not accept checks. Checks may not be honored. Checks must be deposited in a bank, after which there is a waiting period before the funds are available. Processing personal checks includes a heavy overhead of copying every check to microfilm for archival.

Bank checks are burdensome. A person has to physically go to his bank to get a bank check, and he has to know the exact amount of the payment for which the bank check is intended.

Bank transfers are also burdensome. A person has to issue explicit instructions to his bank to make a transfer. While this is worth the effort for scheduled payments to vendors such as credit card companies, utility companies, suppliers, tax authorities and department stores, it would require substantial time and effort to use bank transfers for day to day non-scheduled payments.

Credit cards are vulnerable. There is substantial use of stolen credit cards or stolen credit card numbers, which has cost consumers and the credit card companies billions of dollars. Credit cards have to be sent in the mail. Merchants may neglect to verify credit card validity or overdrawn credit limits. Merchants may have to refuse a sale because their point-of-sale terminal is not currently able to connect to a credit card company for authorization. Not all merchants around the world accept credit cards. Credit cards can only be used for paying merchants, and cannot be used for transferring funds from individual to individual.

Recently, the advent of microchips has made it possible to incorporate a small microprocessor chip and non-volatile memory onto a card, referred to as a “smart card”. Smart cards are currently able to function as cash accounts and to provide secure authentication with merchant point-of-sale terminals. However, smart cards also have their drawbacks. Smart cards can run out of money. Smart cards can only be replenished by replacing the cards, or by passing the cards through bank machines. Smart cards, like credit cards, cannot be used for transferring funds from individual to individual.

### SUMMARY OF THE DESCRIPTION

The present invention concerns computerized banking, payment systems and digital cash. The present invention includes a small, forgery-resistant device, referred to as a “payment device”, which is personalized so that only its rightful owner may use it. A payment device is associated with one or more bank accounts belonging to its owner.

After being authenticated by his payment device, the owner may identify himself via the payment device to an external system, including a merchant's point-of-sale terminal or a bank's electronic funds transfer system or another payment device, and then perform a financial transaction. User identification is such that only selected credentials are released, without releasing any unrelated owner information.

The payment device of the present invention includes data processing and data storage capability, which the owner may use to maintain personal and financial data. The payment device protects its owner's data by cryptographic security, and the data can only be accessed by a properly authorized financial institution or the rightful owner himself. The payment device uses a secure communication protocol and, as such, data transmitted by the payment device over a communication link cannot be eavesdropped. Moreover, an identity of the device owner cannot be determined from his transaction data. It may thus be appreciated that the payment device provides maximum protection of privacy.

The payment device of the present invention is particularly advantageous in performing person-to-person funds transfer. A first owner can perform a payment transaction to a second owner via the owners' respective payment devices. The payment transaction is encrypted, and can only be decrypted by a bank computer that manages the owners' respective bank accounts and that commits the transaction between the accounts.

There is thus provided in accordance with an embodiment of the present invention an electronic funds system, including a plurality of payment devices, each payment device including a payment application for (i) transferring funds to another payment device, (ii) receiving funds from another payment device, and (iii) synchronizing transactions with a bank server computer, a queue manager for queuing transactions for synchronization with the bank server computer, an encoder for encrypting transaction information, a proximity communication module for wirelessly communicating with another of the plurality of payment devices over a short range, a wireless communication module for communicating with a client computer and with the bank server computer over a long range, a plurality of client computers, each client computer including a payment device manager for (i) transmitting funds to a payment device, (ii) receiving funds from a payment device, and (iii) setting payment device parameters, and a wireless communication module for communicating with at least one of the plurality of payment devices and with a bank server computer over a long range, and at least one bank server computer, each bank server computer including an account manager for (i) managing at least one bank account associated with at least one of the payment devices, and (ii) processing transactions received from the plurality of payment devices, a decoder for decrypting encrypted transaction information, and a wireless communication module for communicating with the plurality of payment devices and with the plurality of client computers over a long range.

There is moreover provided in accordance with an embodiment of the present invention a mobile wireless communication device for transferring money between users, including a receiver for receiving instructions to transfer money from a second user to a first user, a transmitter for sending instructions to transfer money from the first user to the second user, an instruction formatter for formatting and encrypting an instruction to transfer money, the instruction including at least a transaction identifier, a source account identifier, a destination account identifier, a date of transfer, and an amount to be transferred; and a synchronizer for queuing received instructions and for sending the queued instructions to a bank computer when communication with the bank computer is available.

There is further provided in accordance with an embodiment of the present invention a method for transferring money between users, including receiving instructions to transfer money from a second user to a first user, where an instruction includes at least a transaction identifier, a source account identifier, a destination account identifier, a date of transfer, and an amount to be transferred, queuing the received instructions, sending the queued instructions to a bank computer when communication with the bank computer is available, encrypting instructions to transfer money from the first user to the second user, and sending the encrypted instructions to the second user.

There is yet further provided in accordance with an embodiment of the present invention a computer readable storage medium storing program code for causing a computing device to receive instructions to transfer money from a second user to a first user, where an instruction includes at least a transaction identifier, a source account identifier, a destination account identifier, a date of transfer, and an amount to be transferred, to queue the received instructions, to send the queued instructions to a bank computer when communication with the bank computer is available, to encrypt instructions to transfer money from the first user to the second user, and to send the encrypted instructions to the second user.

### BRIEF DESCRIPTION OF THE DRAWINGS

The present invention will be more fully understood and appreciated from the following detailed description, taken in conjunction with the drawings in which:

FIG. 1 is a simplified block diagram of mobile wireless payment devices that transfer funds among users, in accordance with an embodiment of the present invention;

FIG. 2 is a simplified block diagram of an account-to-account payment and management system, in accordance with an embodiment of the present invention;

FIG. 3 is a simplified flowchart of a method for making a person-to-merchant payment transaction, in accordance with an embodiment of the present invention;

FIG. 4 is a simplified flowchart of a method for making a person-to-person payment transaction, in accordance with an embodiment of the present invention;

FIG. 5 is a simplified flowchart of a method for synchronizing a payment device with a bank account, in accordance with am embodiment of the present invention; and

FIG. 6 is a simplified block diagram of a payment device, in accordance with an embodiment of the present invention.

### DETAILED DESCRIPTION

The present invention relates to computerized banking and digital funds.

In accordance with the present invention, users have financial accounts that are controlled by one or more banks. Users have wireless access to at least one cash account via a hardware unit referred to hereinbelow as a “payment device”. The present invention does not require a live connection between a payment device and a bank. Instead, a user periodically synchronizes his payment device with his bank.

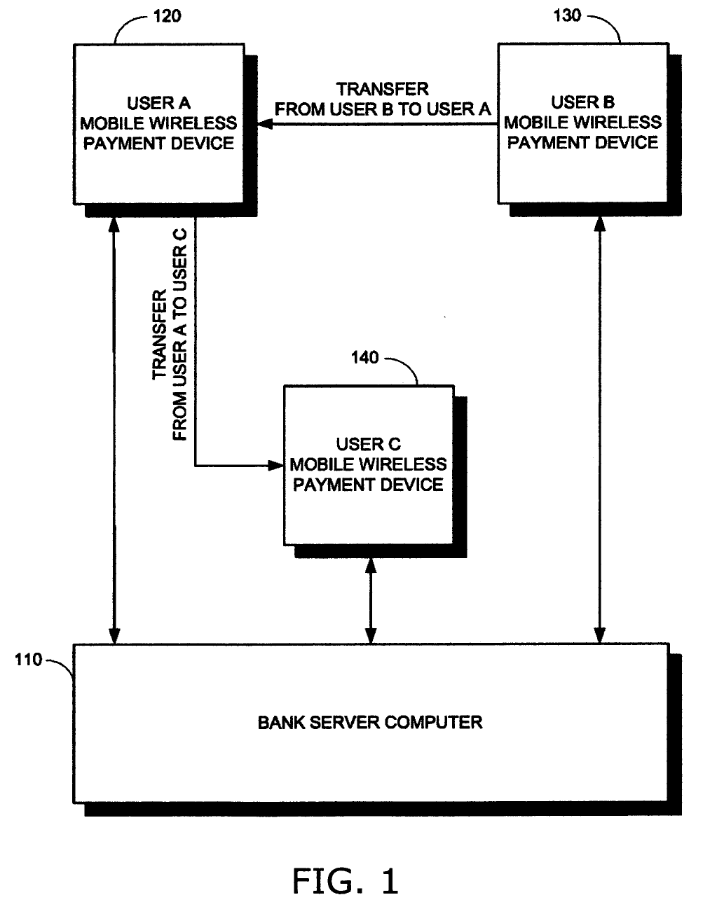

Reference is now made to FIG. 1, which is a simplified block diagram of mobile wireless payment devices that transfer funds among users, in accordance with an embodiment of the present invention. Shown in FIG. 1 is a bank server computer 110, which manages user accounts, and three mobile wireless payment devices 120, 130 and 140 belonging to user A, user B and user C, respectively. Payment devices 120, 130 and 140 are operative (i) to transfer funds between two users, and (ii) to synchronize the funds transfers with the users' bank accounts via bank computer 110. Moreover, as distinct from cards, the payment devices of the present invention transfer funds between two users whether or not the users' payment devices are currently in communication with bank computer 110. The funds transfer transaction does not have to be immediately authorized. Instead, the transaction is queued and is subsequently synchronized with the relevant bank accounts.

It will be appreciated that bank server computer 110 may be a plurality of computers, associated with one or more banks. That is, users A, B and C may have their accounts at the same bank or at different banks. Generally, each bank is uniquely identified by a specific bank routing number, and each user account is uniquely identified by a specific account number within a specific bank.

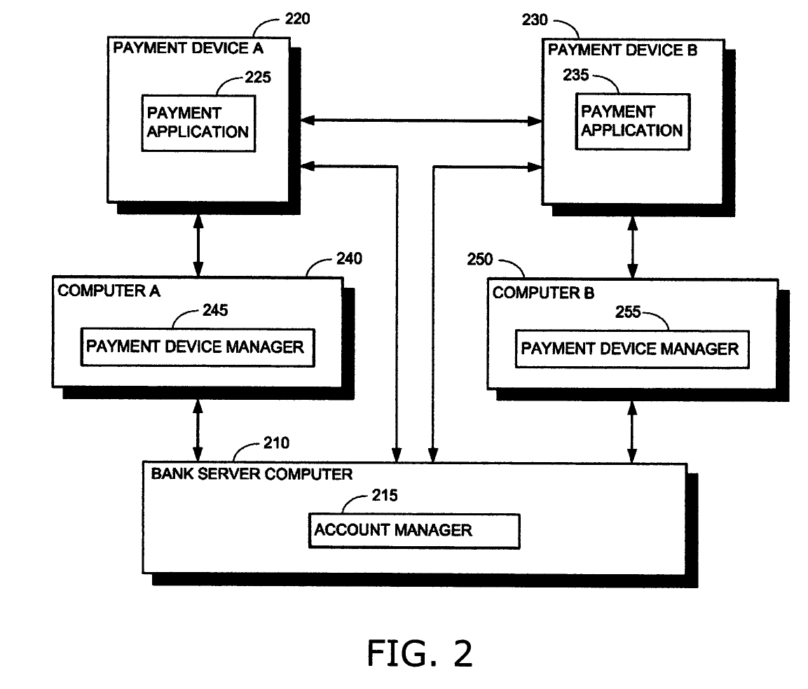

Reference is now made to FIG. 2, which is a simplified block diagram of an account-to-account payment and management system, in accordance with an embodiment of the present invention. Shown in FIG. 2 is a bank server computer 210 and two payment devices, A and B, designated by numerals 220 and 230, respectively, and belonging to respective users A and B.

Bank server computer 210 includes an account manager 215, for managing a plurality of user bank accounts, including inter alia bank accounts of user A and user B. Account manager 215 is able to receive an encrypted transaction in the form of a funds transfer from one user's account to another, execute or decline the transaction as appropriate, and return an acknowledgement of success or failure. Account manager 215 also enables a payment device to access account details including inter alia an account balance and a transaction history.

Payment devices A and B include respective payment applications 225 and 235, used to transfer funds between a payment device and a bank account, and between one payment device and another payment device. Also shown in FIG. 2 are client computers A and B, designated by numerals 240 and 250, respectively, and belonging to users A and B, respectively. Client computers A and B include respective payment device managers 245 and 255, respectively.

When a user's payment device is in communication with the user's computer, the user can set his device parameters, and can upload and download data between the device and the computer. Device parameters include, inter alia, a password, a daily cash limit, a daily number of transactions limit and text descriptors. Data uploaded from the device to the computer includes inter alia recent transactions.

When a user's payment device is in communication with bank server computer 210, the user's queued transactions are committed, and the user can retrieve his account information including inter alia his current balance, a list of his recent transactions, and his current daily limits on cash transfer and number of transactions.

When a user's computer is in communication with bank server computer 210, the user can upload and download data between his computer and bank computer 210. Data downloaded from bank computer 210 includes inter alia an account summary and recent transactions.

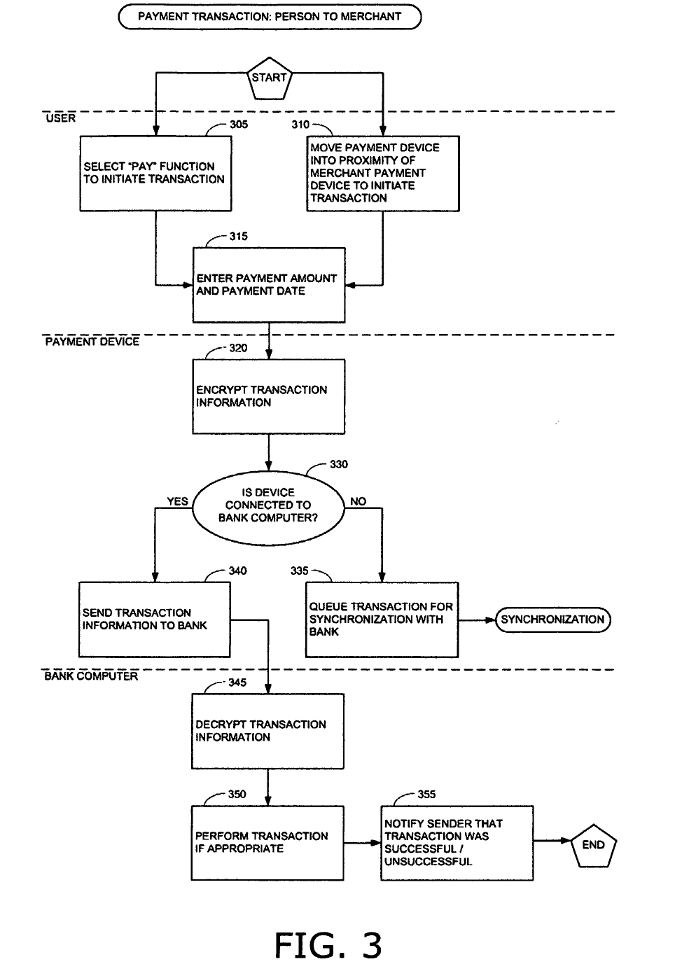

Reference is now made to FIG. 3, which is a simplified flowchart of a method for making a person-to-merchant payment transaction, in accordance with an embodiment of the present invention. The flowchart of FIG. 3 is divided into three horizontal sections. The top section indicates steps performed by a user. The middle section indicates steps performed by the user's payment device. The bottom section indicates steps performed by a bank server computer.

To perform a person-to-merchant transaction, the user initiates a transaction by either activating a “pay” function on his payment device at step 305, or by waving his payment device in close proximity to the merchant's payment device at step 310. Once the user's and merchant's payment devices are in communication, the devices perform a handshake operation to verify that the one is authorized to send money and the second is authorized to receive money. If the handshake is successful, then a payment application is launched on both payment devices and a transaction is initiated. The merchant's payment device wirelessly transmits merchant identification to the user's payment device. Alternatively, the user's payment device may have the merchant identification already stored, in which case the user's payment device need only bring up the stored merchant information.

At step 315 the user enters the payment amount he wishes to pay to the merchant, and a scheduled date of payment, into his payment device. The user is asked to confirm the transfer. In order to perform step 315, the user may first have to authenticate himself to the payment application by typing a password, or by having a biometric scan, or both.

At step 320 the payment device encrypts the transaction information using an asymmetric encryption algorithm, such as RSA encryption, using a pre-stored encryption key. At step 330 the payment device determines whether or not it has a communication connection with the bank server computer. If not, then the transaction is queued for synchronization with the bank at step 335. If the payment device does have a communication connection with the bank server computer, then at step 340 the payment device sends the transaction information to the bank server computer.

At step 345 the bank server computer receives the transaction information from the payment device, and decrypts the information. At step 350 the bank computer validates and commits the transaction as appropriate. Specifically, if the user's bank account and payment device are currently valid, if there are no data transmission errors, if the transaction is authenticated, and if the user has sufficient funds in his bank account, then the transaction is committed. Otherwise, the transaction is declined. At step 355 the bank server computer notifies the user that his transaction was successful or unsuccessful, as appropriate. If the transaction was declined, then the bank server computer may advise the user as to the reason for denial and what course of action to follow. Optionally, the user's payment device may be configured to send a text message to an Internet address designated by the user. The text messages enable the user to track his purchases and to be aware if there is fraudulent use of his payment device.

Generally there are at least two levels of authentication; namely, (i) authentication of a payment device into its wireless network to ensure that it is the device making the transaction, that it is authorized and that its payments are current, and (ii) authentication of a user to a payment application. Level (i) authentication is performed by having the payment device authenticate itself to a wireless carrier.

Level (ii) authentication is performed by personalizing a payment device so that its rightful owner, and only its rightful owner, is granted access to the information and accounts controlled by the payment device. Such authentication may be implemented inter alia by a username/password combination, or by biometric authentication, or both.

In accordance with an embodiment of the present invention, when a user receives his payment device initially from his bank, the user is given a password, which serves as an access code. As a default, the access code is required for any transaction; however, the user may change the default settings so that he is only required to enter his access code when a transaction exceeds a preset amount, such as $100, or when the user hasn't authenticated himself for over a preset time interval such as 1 hour.

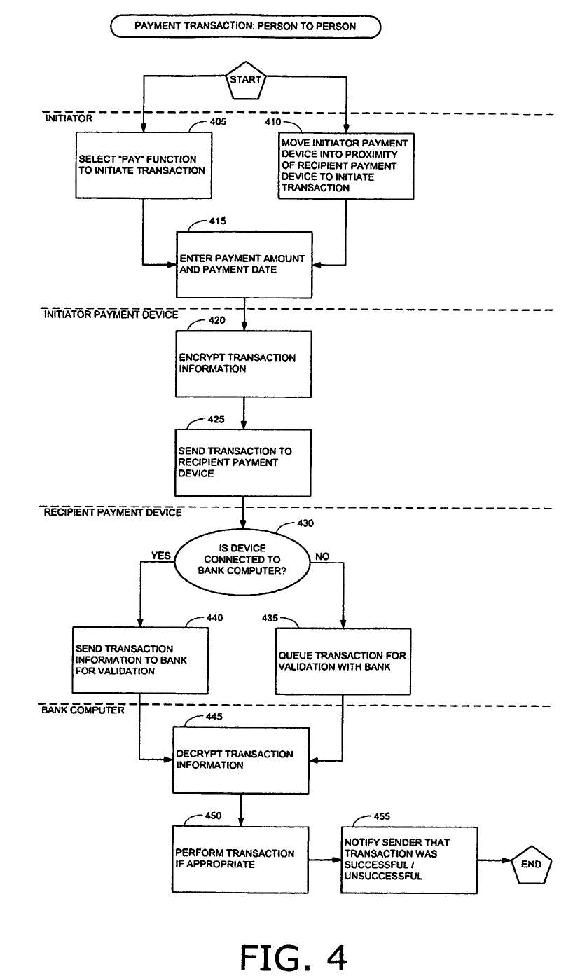

Reference is now made to FIG. 4, which is a simplified flowchart of a method for making a person-to-person payment transaction, in accordance with an embodiment of the present invention. Specifically, the method illustrated involves a first user, referred to as a transaction initiator, who pays a second user, referred to as a transaction recipient. The flowchart of FIG. 4 is divided into four horizontal sections. The topmost section indicates steps performed by the transaction initiator. The section second from the top indicates steps performed by the initiator's payment device. The section third from the top indicates steps performed by the recipient's payment device. The bottommost section indicates steps performed by a bank server computer.

As above with respect to FIG. 3, to initiate the transaction, the initiator either activates a “pay” function at step 405, or else waves his payment device into close proximity with the recipient's payment device at step 410. Once the initiator's and recipient's payment devices are in communication, the devices perform a handshake operation to verify that the one is authorized to send money and the second is authorized to receive money. If the handshake is successful, then a payment application is launched on both payment devices and a transaction is initiated. The recipient's payment device wirelessly transmits recipient identification to the user's payment device. Alternatively, the user's payment device may have the recipient identification already stored, in which case the user's payment device need only bring up the stored recipient information.

At step 415 the initiator enters a payment amount and a date for scheduling the payment into his payment device. As above with respect to FIG. 3, in order to perform step 415, the user may first have to authenticate himself to the payment application by typing a password, or by having a biometric scan, or both.

At step 420 the initiator's payment device encrypts the transaction information using an asymmetric encryption algorithm, such as RSA. At step 425 the initiator's payment device sends the transaction information to the recipient's payment device.

At step 430 the recipient's payment device determines whether or not it has a communication connection with the bank server computer. If not, then at step 435 the recipient's payment device queues the transaction for subsequent validation and processing. If the recipient's payment device does have a communication connection with the bank server computer, then at step 440 the recipient's payment device sends the transaction information to the bank server computer for validation and processing.

When the bank server computer receives the transaction information from the recipient's payment device, either when the recipient payment device is connected to the bank server computer subsequent to step 435, or immediately after step 440, the bank server computer decrypts the transaction information at step 445. At step 450 the bank server computer validates and commits the transaction as appropriate. Specifically, if the initiator's and the recipient's bank accounts and payment devices are current, if the transaction is authenticated, and if the initiator has sufficient funds in his account, then the transaction is committed. Otherwise, the transaction is declined. At step 455 the bank server computer notifies the recipient that the transaction was successful or unsuccessful, as appropriate.

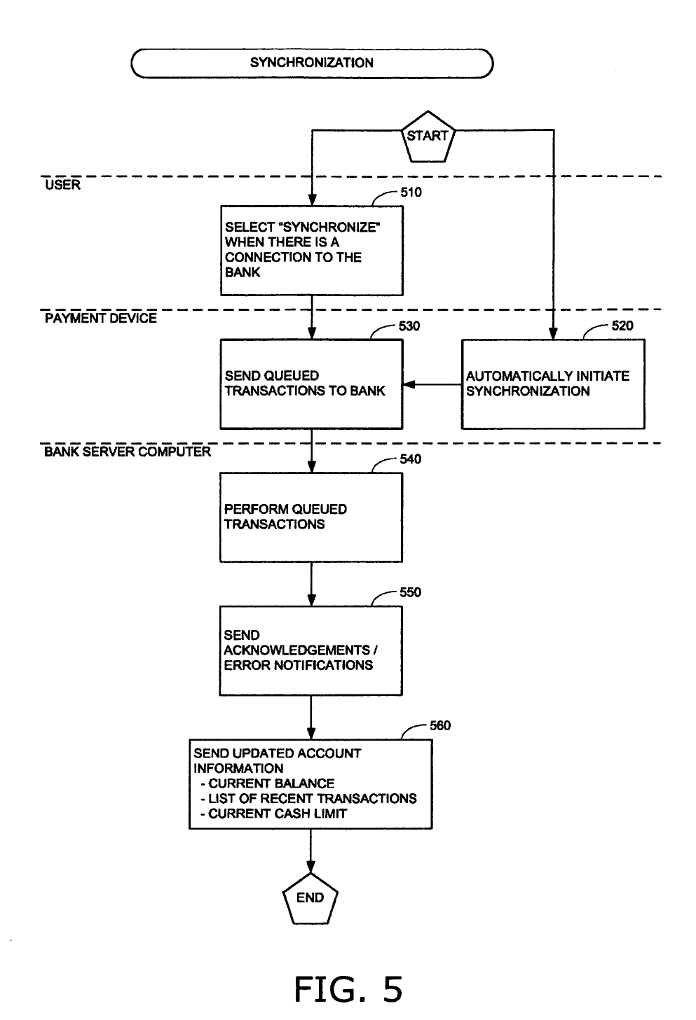

In comparing FIG. 4 with FIG. 5, it is noted that if the recipient is a merchant, the transaction is sent to the initiator's bank; whereas if the recipient is an individual the transaction is sent to the recipient. The recipient is thus assured that the transaction has occurred. The recipient subsequently sends the transaction to the recipient's bank, where the transaction is decrypted and committed. In both FIG. 4 and FIG. 5, if there is no available connection at the time of the transaction, then the transaction is queued for subsequent synchronization.

Reference is now made to FIG. 5, which is a simplified flowchart of a method for synchronizing a payment device with a bank account, in accordance with am embodiment of the present invention. The flowchart of FIG. 5 is divided into two horizontal sections. The top section indicates steps performed by a user. The middle section indicates steps performed by a user's payment device. The bottom section indicates steps performed by a bank server computer.

The method of FIG. 5 is initiated when a user's payment device is synchronized with his bank account, such as after step 340 of FIG. 4. The user may manually initiate the synchronization, as indicated at step 510, by the user activating a “synchronize” function while his payment device is connected to the bank server computer. Alternatively, a payment application running in the payment device may automatically attempt to synchronize, as indicated at step 520; or both manual and automated synchronization may be operative. The user's payment device initiates an Internet connection and sends the user's account information to the bank server computer. The bank server computer may require authentication prior to permitting synchronization, e.g., by issuing a challenge question to the user. If the user correctly answers the question, then synchronization proceeds. Otherwise, the user's account is frozen and a notification is sent to the payment device advising the user of such. Authentication may be required whenever the user's account is on alert, such as when suspicious activity is detected.

At step 530, the user's payment device then sends its queued transactions to the bank server computer. At step 540 the bank server computer receives and performs the user's queued transactions as appropriate. At step 550 the bank server computer sends acknowledgements for queued transactions that were successful and error notifications for queued transaction that were declined. At step 560 the bank server computer sends the user's updated account information to his payment device.

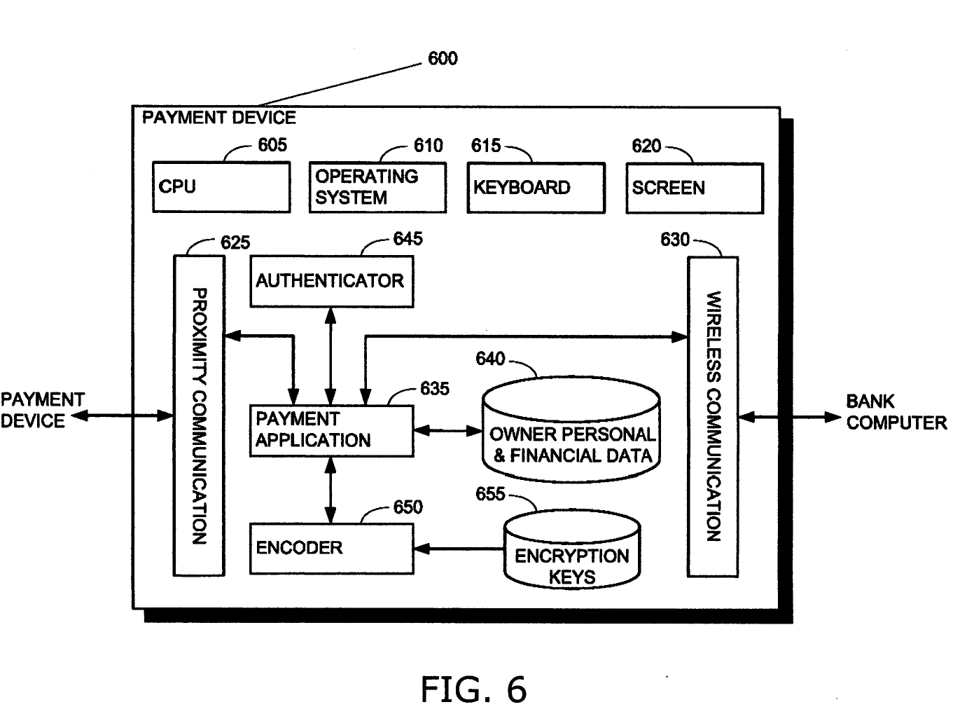

Reference is now made to FIG. 6, which is a simplified block diagram of a payment device 600, in accordance with an embodiment of the present invention. Payment device 600 is embodied within a smart phone or as a PDA, or such other conventional or custom hardware device. Included within device 600 is a CPU processor 605 and an operating system 610. When payment device 600 is part of a smart phone or PDA, CPU 605 may be the smart phone processor or PDA processor, respectively. Alternatively, CPU 605 may be embedded within a SIM chip or such other conventional or custom processing unit.

For user input, payment device 600 may include various buttons and jog wheels, as well as a keyboard 615. For user output, payment device 600 may include a display screen 620.

Payment device 600 is able to communicate wirelessly with another payment device when the devices are in close proximity to one another, using a proximity communication module 625. Module 625 may use Bluetooth, Near-Field Communication, Radio Frequency Identification communication, infra-red communication, or such other wireless communication technology that operates over short ranges on the order of 1 meter.

Payment device 600 is also able to communicate wirelessly with one or more bank server computers, using a wireless communication module 630. Wireless communication module 630 also enables payment device 600 to communicate with electronic funds transfer (EFT) systems.

Processor 600 includes a payment application 635, used for generating and performing transactions, including inter alia the transactions illustrated in FIGS. 3-5. Payment application 635 reads and writes its owner's personal and financial data, stored in a data store 640, and sends and receives transactions to other payment devices via proximity communication module 625. Payment application 635 synchronizes its transactions with one or more bank server computers and with EFT systems, via wireless communication module 630.

Payment device 600 further includes an authenticator 645 for validating a user. Authenticator 645 operates by validating a password entered by the user, or by recognizing a biometric of the user, or both.

Processor 600 also includes an encoder 650 for encrypting transaction information, and a data storage 655 of encryption keys.

In addition to functioning as a funds transfer tool, payment device 600 supports offline user services that are not part of a transaction, and are available to a user at any time. Such services include inter alia generating transaction lists, reporting available balances, and tracking expenses. The payment device enables a user to categorize expenses, and to export this information to a data file or to a financial application such as Quicken.

In reading the above description, persons skilled in the art will realize that there are many apparent variations that can be applied to the methods and systems described. Thus it may be appreciated that the present invention applies to configurations where each user may have multiple payment devices, where each payment device may be associated with one or more bank accounts managed by one or more banks. For payment devices associated with more than one bank account, a user is able to select which bank account it to be used for payment transactions, and to change his selection from time to time. It will be appreciated that such a mechanism enables a single payment device to function as multiple credit cards.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. An electronic funds system, comprising:
a plurality of payment devices, each payment device comprising:
a payment application for (i) transferring funds to another payment device, (ii) receiving funds from another payment device, and (iii) synchronizing transactions with a bank server computer;
a queue manager for queuing transactions for synchronization with the bank server computer;
an encoder for encrypting transaction information;
a proximity communication module for wirelessly communicating with another of said plurality of payment devices over a short range;
a wireless communication module for communicating with a client computer and with the bank server computer over a long range;
a plurality of client computers, each computer comprising:
a payment device manager for (i) transmitting funds to a payment device, (ii) receiving funds from a payment device, and (iii) setting payment device parameters; and
a wireless communication module for communicating with at least one of said plurality of payment devices and with a bank server computer over a long range; and
at least one bank server computer, each bank server computer comprising:
an account manager for (i) managing at least one bank account associated with at least one of said payment devices, and (ii) processing transactions received from said plurality of payment devices;
a decoder for decrypting encrypted transaction information; and
a wireless communication module for communicating with said plurality of payment devices and with said plurality of client computers over a long range.

2. The electronic funds system of claim 1 wherein each of said plurality of payment devices are housed within a smart phone.

3. The electronic funds system of claim 1 wherein each of said plurality of payment devices are housed within a personal data assistant (PDA).

4. The electronic funds system of claim 1 wherein said proximity communication module uses Near Field Communication (NFC).

5. The electronic funds system of claim 1 wherein said proximity communication module uses Bluetooth.

6. The electronic funds system of claim 1 wherein said proximity communication module uses Radio Frequency Identification (RFID).

7. The electronic funds system of claim 1 wherein each of said plurality of payment devices further comprises an authentication module for validating a user.

8. The electronic funds system of claim 7 wherein said authentication module validates a user by validating a password entered by the user.

9. The electronic funds system of claim 7 wherein said authentication module validates a user by recognizing a biometric of the user.

10. The electronic funds system of claim 1 wherein the payment device parameters include a daily cash limit.

11. The electronic funds system of claim 1 wherein the payment device parameters include a daily number of transactions limit.

12. The electronic funds system of claim 1 wherein the payment device parameters include a password.

13. A mobile wireless communication device for transferring money between users, comprising:
a receiver for receiving instructions to transfer money from a second user to a first user;
a transmitter for sending instructions to transfer money from the first user to the second user;
an instruction formatter for formatting and encrypting an instruction to transfer money, the instruction including at least a transaction identifier, a source account identifier, a destination account identifier, a date of transfer, and an amount to be transferred; and
a synchronizer for queuing received instructions and for sending the queued instructions to a bank computer when communication with the bank computer is available.

14. A method for transferring money between users, comprising:
receiving instructions to transfer money from a second user to a first user, where an instruction includes at least a transaction identifier, a source account identifier, a destination account identifier, a date of transfer, and an amount to be transferred;
queuing the received instructions;
sending the queued instructions to a bank computer when communication with the bank computer is available;
encrypting instructions to transfer money from the first user to the second user; and
sending the encrypted instructions to the second user.

15. The method of claim 14 wherein the received instructions are received encrypted instructions.

16. The method of claim 14 further comprising authenticating the first user prior to said sending the encrypted instructions.

17. The method of claim 16 wherein said authenticating comprises validating a password entered by the first user.

18. The method of claim 17 further comprising:
receiving parameters from a client computer, the parameters including at least a password; and
applying the received parameters when performing said validating.

19. The method of claim 16 wherein said authenticating comprises recognizing a biometric of the first user.

20. The method of claim 14 further comprising authenticating the first user prior to said sending the queued instructions.

21. The method of claim 20 wherein said authenticating comprises validating a password entered by the first user.

22. The method of claim 21 further comprising:
receiving parameters from a client computer, the parameters including at least a password; and
applying the received parameters when performing said validating.

23. The method of claim 20 wherein said authenticating comprises recognizing a biometric of the first user.

24. The method of claim 14 further comprising:
receiving parameters from a client computer, the parameters including at least one of a cash limit and a number of transactions limit; and
applying the received parameters prior to said sending the encrypted instructions.

25. A computer readable storage medium storing program code for causing a computing device:
to receive instructions to transfer money from a second user to a first user, where an instruction includes at least a transaction identifier, a source account identifier, a destination account identifier, a date of transfer, and an amount to be transferred;
to queue the received instructions;
to send the queued instructions to a bank computer when communication with the bank computer is available;
to encrypt instructions to transfer money from the first user to the second user; and
to send the encrypted instructions to the second user.
